(19) United States
(12) Patent Application Publication
(10) Pub. No.: US 2014/0164477 A1
(43) Pub. Date: Jun. 12, 2014

(54) SYSTEM AND METHOD FOR PROVIDING HORIZONTAL SCALING OF STATEFUL APPLICATIONS

(71) Applicants: Gary M. Springer, Johns Creek, GA (US); Clint E. Ricker, Dacula, GA (US); Nick George Pope, Suwanee, GA (US)

(72) Inventors: Gary M. Springer, Johns Creek, GA (US); Clint E. Ricker, Dacula, GA (US); Nick George Pope, Suwanee, GA (US)

(21) Appl. No.: 13/707,094

(22) Filed: Dec. 6, 2012

(51) Int. Cl. H04L 29/08

(52) U.S. Cl. CPC H04L 67/1004
USPC 709/203

(57) ABSTRACT

A method is provided in one example embodiment and includes receiving an inbound request from a client; retrieving state information for a targeted application; modifying the inbound request with the state information from a data store; forwarding the inbound request that was modified to an application running on a server instance; and providing a response to the client based on information provided by the application.

### TECHNICAL FIELD

This disclosure relates in general to the field of communications and, more particularly, to a system and a method for providing horizontal scaling of stateful applications.

### BACKGROUND

End users have more media and communications choices than ever before. A number of prominent technological trends are currently afoot (e.g., more computing devices, more online video services, more Internet video traffic), and these trends are changing the network landscape. Separately, these trends are pushing the limits of capacity and, further, degrading the performance of many systems, where such degradation creates frustration amongst end users, on-line retailers, and service providers.

In certain transactional environments, any proposed architecture should offer high availability characteristics, as well as accommodate scale. For example, the failures of network servers should not cause a system outage. Additionally, cloud applications should support high-transaction rates, as well as provide the ability to increase scaling by adding additional servers. Hence, there are numerous challenges for optimizing many network activities that involve transactional flows.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for providing horizontal scaling of stateful applications in accordance with one embodiment of the present disclosure;

FIG. 2A is a simplified block diagram illustrating possible example details associated with one embodiment of the present disclosure;

FIG. 2B is a simplified flowchart illustrating potential operations associated with the communication system in accordance with one embodiment of the present disclosure;

FIG. 3 is a simplified block diagram illustrating one potential example associated with a recorder manager architecture; and

FIGS. 4A-4D are simplified flowcharts illustrating potential operations associated with the recorder manager architecture.

### DETAILED DESCRIPTION OF EXAMPLE EMBODIMENTS

### Overview

A method is provided in one example embodiment and includes receiving (e.g., over any suitable interface and using any appropriate format) an inbound request from a client. The method also includes retrieving state information for a targeted application and modifying the inbound request with the state information from a data store (e.g., a database, a distributed hash table (DHT) data store, a repository, data center equipment, any other suitable storage location, etc.). The term ‘modifying’ in the sense is meant to include any type of altering, changing, decorating, augmenting, adjusting, amending, revising, updating, or otherwise processing the state information. The method can also include forwarding (i.e., communicate in any fashion) the inbound request that was modified to an application running on a server instance. The method can also include providing a response to the client based on information provided by the application. The response can include any suitable information that is responsive to the request.

In more particular environments, an application session manager (ASM) is provided to intercept (i.e., take from, or at least receive a copy of) a plurality of events associated with a transaction involving the inbound request, and a state record is systematically updated by the ASM based on the plurality of events. In yet other instances, state information from each step of a transaction is maintained as XML-structured information in a document associated with a session state record (SSR). The application running on server instance can see the inbound request that was modified as if the client had supplied the state information.

An application session manager can operate as a frontend to a plurality of client requests and for mid-session phases to transparently maintain and present state information at a beginning of a session transaction or session phase. In certain implementations, an adapter is coupled to the client and configured to implement a legacy protocol and to convert an incoming message payload to an XML format. A load balancer can be provided to distribute incoming requests from a plurality of clients across a set of stateless server instances. In at least one example embodiment, the inbound request is associated with a cloud digital video recorder (DVR) recorder manager that is to provide video content management for the client.

### Example Embodiments

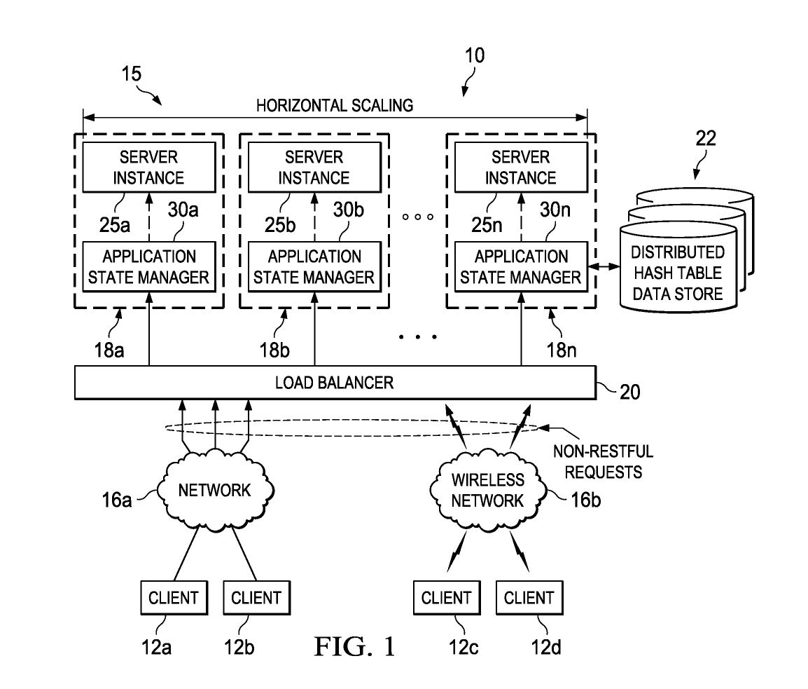

Turning to FIG. 1, FIG. 1 is a simplified block diagram of a communication system 10 configured for providing horizontal scaling of stateful applications for various clients in accordance with one embodiment of the present disclosure. Communication system 10 includes horizontal scaling (generally indicated as an arrow 15), a plurality of clients 12a-d, a load balancer 20, a set of networks 16a-b, a plurality of server instances 25a-n, a distributed hash table (DHT) data store 22, and a plurality of application state managers 30a-n.

Server instances 25a-n and application state managers 30a-n may be consolidated (e.g., collocated) in a single location/device/equipment, which is generally indicated by hashed boxes 18a-n. In a particular embodiment, server instances 25a-n are configured to deliver response content to one or more clients 12a-d. The content may be associated with any appropriate transaction and, therefore, include any suitable information and/or data that can propagate in the network (e.g., video, audio, media, any type of streaming information, etc.). Certain transactional information or content may be stored in distributed hash table data store 22, which can be provisioned anywhere in the network. Distributed hash table data store 22 may be a part of any data center infrastructure, storage equipment generally, web server devices: all of which can be accessed at any suitable time. Typically, server instances mount to the same file system, point to the same database, etc. such that they can share state information.

In accordance with the teachings of the present disclosure, communication system 10 can be configured to provide a mechanism for allowing a stateful application to appear stateless to a frontend for purposes of loadbalancing. The term “frontend” in this context can refer to any type of data center infrastructure, load balancer, or any other equipment that could help manage incoming connections for a particular server. It should be understood that the loadbalancing can be made simpler if the application appears to be stateless.

In one general sense, aspects of the present disclosure can frontend servers (as opposed to backending the servers), where inbound requests can be decorated (i.e., modified) with state information, as further discussed below. One feature of the architecture proposed herein involves maintaining and persisting state information at each step of a service delivery transaction. Such a method could allow, for example, the use of stateless software instances that can be horizontally scaled and, further, provide for the appropriate high availability. Such a method could be transparent to software developers and require no explicit instructions for retaining and persisting state information. Additional details are provided below with reference to the accompanying FIGURES. Before detailing these activities in more explicit terms, it is important to understand some of the challenges encountered in a network that facilitates transactions for numerous clients. The following foundational information may be viewed as a basis from which the present disclosure may be properly explained.

Service delivery applications typically require high availability (HA) and high transaction rate scaling. These two requirements are closely related with design solution choices for one requirement affecting the other. System availability is usually defined in terms of the number of nines of per-cent availability of the system. For example, four nines indicates 99.99-% availability. Service delivery system HA generally requires that the failure of a single component does not impact the delivery to more than a single user. Client device failures are generally not considered to be an issue since a single user is affected with a small effect on system availability. However, server components that affect multiple users represent a significant contributor to system availability and, therefore, some form of HA is required to prevent server failure from affecting users. The common approach for legacy applications is to use hot-standby devices to replace failed components. The hot-standby approach uses a replacement component with state that is synchronized to the primary device to allow an immediate transition to a service. For detection of a failure of the primary device, the standby device transitions online and replaces the failed component. A virtual address or an application program interface (API) is employed with the result that the change is transparent to client devices. This approach is commonly used in stateful control systems, but it suffers from two large disadvantages. First, the resultant software and the operational support mechanisms are too complex. Second, the approach requires extra resources that should be active at all times, but that are only used in the event of failure, which results in higher costs and increased power consumption.

Service delivery applications should also offer a method of scaling to support increasing transaction rates, as a service is deployed with growth in the number of customers. Network servers should process high transaction rates and should also provide a mechanism to accommodate increasing transaction rates, as the applications grow. One approach is a fixed partitioning of servers. Multiple servers would handle the transaction load with servers partitioned for a segment of the population of users. This approach works generally, but it is not flexible and it imposes a burden on operations when scaling the system to provide more capacity.

Aspects of the present disclosure can potentially address these issues, as well as others, in providing an architecture that solves the problems of HA and scale (e.g., in modern Internet applications) using a Representational State Transfer (REST) design architecture. Multiple stateless server instances can provide services to clients. Load balancer 20 is configured to direct incoming requests to one of a group of server instances that can provide horizontal scaling. With horizontal scaling, adding additional server instances can provide more capacity. Such an approach is enabled by the REST architecture, where clients maintain state that is provided to the server as part of the request. This technique can also provide simple active-active HA. Load balancer 20 monitors the state of the server instances and marks un-responding servers as out-of-service. Incoming requests can be routed to servers that are functional.

DHT data store 22 can offer an enabling component of a new approach to achieve HA and scale. DHT provides fault tolerance, resiliency, and rapid access time. These characteristics qualify DHT as a HA-enabled component of a service delivery system. That is, the availability of the DHT qualifies the DHT component to be used as a component in a system with sufficient availability to not be considered as a single point of failure. In addition, the rapid access time allows the component to be used as a data service with minimum delay in the transaction processing. DHT can add nominal delay to each phase of transaction processing, but enable the advantage of horizontal scale and parallel processing of transactions.

DHT is an open source, distributed, key-value data store. Membase was developed to serve as the data store behind high-transaction rate internet applications. Using Membase as the data store can enable simple horizontal scaling, where multiple servers could share load to support high transaction rates with resiliency. Membase can be deployed as a simple single server or as a cluster of distributed nodes. When deployed as a set of distributed nodes, Membase provides high availability and, thus, can serve as the data store for an “always on” distributed highly available system.

DHT is designed to be fast, efficient, and simple. Membase can cache data in memory for fast access. With fast gigabit networks, access times are sub-millisecond. This low-latency enables Membase use in applications that typically use proprietary software instead of standard database software. The scale and resiliency of Membase enable the use of Membase as a state repository for high-availability applications.

In the RESTful architectural model, the client maintains state and provides state at each phase of a transaction. Since state retention cannot be a client function for legacy client devices, a fast and high availability data store can provide that function. Intermediate software could maintain state and append state information on a phase of a transaction. If a data store had sufficient availability and access times, a RESTful operation could be applied to legacy client applications and devices. The DHT data store can be used as the method to maintain state in a particular embodiment of the present disclosure; however, the present disclosure is not limited to this methodology (i.e., other data stores could readily be used in conjunction with the teachings of the present disclosure).

DHT is a distributed data store with high-availability and rapid access time. DHT characteristics work well for what is needed for state retention in a model where state retention is required and cannot be provided by the client. Two of the design requirements for DHT were availability and access time. With DHT, storage and processing nodes can be replicated to provide high availability in a manner similar to the previous section. A distributed set of nodes cooperate to provide data store services to applications using a key, value construct. Applications can write a key and corresponding value to the DHT. That data can be cached and accessed rapidly. Multiple nodes can cache the state information at any appropriate time interval. The data are cached in memory to provide rapid access time, limited mainly by network latency.

In terms of application state manager 30a-n, one objective is to enable RESTful techniques for legacy applications and applications where it is not feasible to maintain all state in a client. One embodiment of the present disclosure involves using an external component for maintaining state and for presenting the state on each phase of a transaction. For many applications, it is difficult to accomplish client changes particularly a change of this magnitude requiring legacy applications to be converted to the RESTful technique. It is virtually impossible because of the magnitude of the changes and the regression test cycles. Applying horizontal scaling techniques to legacy stateful applications requires some method for maintaining and persisting state, and for providing that state at processing times.

A DHT used in conjunction with modern fast networks provides sufficient access time to serve as a state cache and provide state from the cache on a transaction processing step. One approach discussed herein is to use the DHT as a data store to maintain state and to transparently provide that step when a transaction step is processed. The approach adds additional delay on a transaction processing step, but offsets this issue by providing a large scale with horizontal scaling.

Software development can be simplified with a mechanism that maintains and persists all state transparently to the software developer. When the external state cache component presents all state from every phase in a structured manner, the software developer need not implement methods for this purpose. Another advantage is that all information in a phase of a transaction is available to all subsequent phases of a transaction. This decouples the software from the protocol data with the application using the mandatory data. Additional data can be added without affecting the application and this data is available when needed by a future requirement or subsequent phase.

One approach outlined by the present disclosure is that state is maintained by an Application State Manager (ASM) component, for example, in an XML document, or in any other suitable document, file, etc. The state from each step of a transaction is maintained as XML-structured information in a document referred to as the session state record (SSR). The broad term ‘session state record’ as used herein is meant to include any type of object, element, data segment, file, log, entry, etc. that can be used to store any type of data, information, etc. associated with state. ASM acts as a frontend to all client requests and mid-session phases to transparently maintain and present state at the beginning of a session transaction step or phase. At the beginning of a service setup transaction, typically a request from client device for service, the ASM creates the SSR. The SSR is maintained in the DHT for resiliency and rapid access. Client-facing adaptors can implement legacy protocols and convert the incoming message payloads to XML stanzas. In certain example implementations, the approach can involve decoding an incoming message payload and inserting the appropriate information in an XML stanza. A number of flowcharts are discussed below that further describe these example activities.

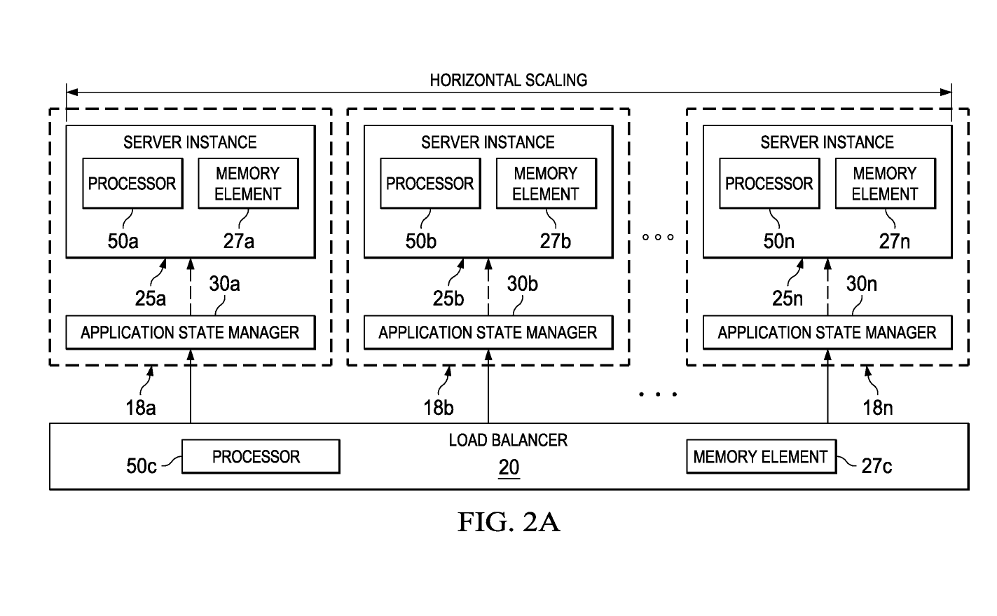

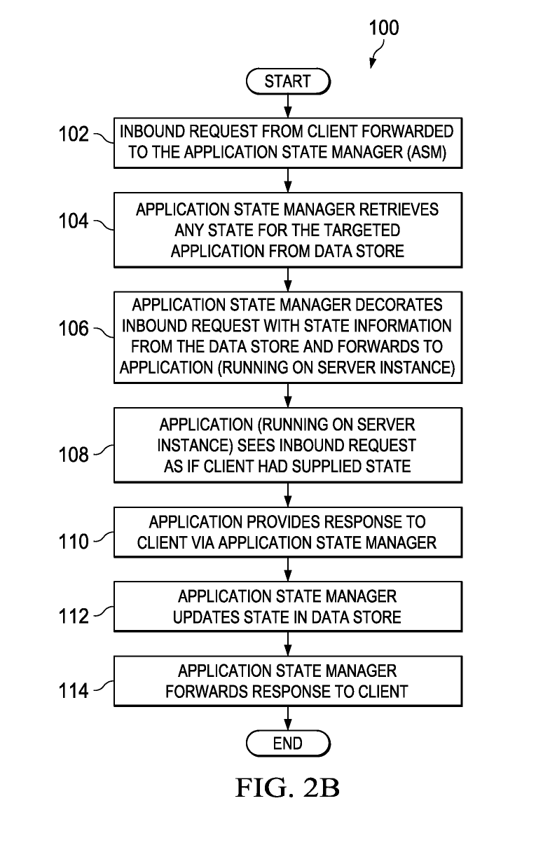

Turning to FIG. 2A, FIG. 2A is a simplified block diagram illustrating possible example details associated with one embodiment of the present disclosure. In this particular example, each server instance 25a-n includes a respective processor 50a , 50b , 50n and a respective memory element 27a, 27b, 27n. In addition, load balancer 20 includes a processor 50c and a memory element 27c.

In operation, transaction steps are presented to a given ASM that maintains state using DHT data store 22 as a repository. The ASM is configured to distribute transaction steps to stateless virtual instances of the processing function. Server instances behind the ASM can be implemented as stateless instances since state is presented to the server instance on a request.

Load balancer 20 is configured to distribute incoming requests and transaction steps across a set of stateless server instances (e.g., using a round robin technique). Load balancer 20 monitors the state of the server instances and marks a non-responding server instance as out-of-service. Server instances marked out-of-service are not included in the scheduling algorithm (e.g., round robin, or any other appropriate algorithm). The result is a horizontal scale with high availability.

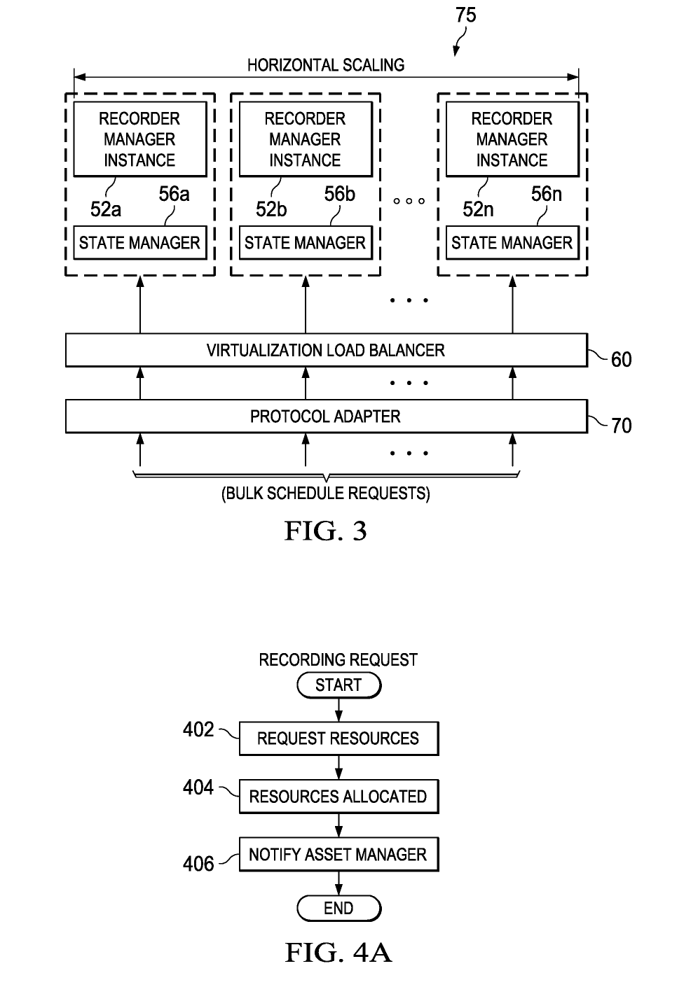

In one implementation, any of ASMs 30a-n, server instances 25a-n, recorder manager instances 52a-n (discussed below with reference to FIG. 3) and/or clients 12a-c can include software to achieve (or to foster) the state management activities discussed herein. Additionally, each of these elements can have an internal structure (e.g., a processor, a memory element, etc.) to facilitate some of the operations described herein. In other embodiments, these state management activities may be executed externally to these elements, or included in some other network element to achieve the intended functionality. Alternatively, ASMs 30a-n, server instances 25a-n, recorder manager instances 52a-n, and/or clients 12a-c may include software (or reciprocating software) that can coordinate with other network elements in order to achieve the state management activities described herein. In still other embodiments, one or several devices may include any suitable algorithms, hardware, software, components, modules, interfaces, or objects that facilitate the operations thereof.

FIG. 2B, FIG. 2B is a simplified flowchart 100 illustrating potential operations associated with communication system 10 in accordance with one embodiment of the present disclosure. This particular flow may begin at 102, where an inbound request from a client is forwarded to an instance of the ASM. At 104, the ASM can retrieve any state for the targeted application from the data store. At 106, the ASM modifies (e.g., decorates) an inbound request with the state information from the data store and, subsequently, forwards it to the application (running on the server instance). At 108, the application (running on the server instance) sees an inbound request as if the client had supplied the state information. At 110, the application provides a response to the client via the ASM. At 112, the ASM updates state information in the data store and, at 114, the ASM forwards a response to client.

Hence, each step of a transaction creates new state information. The initial request to the application can contain state. The response to the request would also contain state. For example, the application can receive a request containing state (service group, bandwidth, client ID, etc.). The application can process the request and generate new information provided in the response. The response information can be appended as the new state information (or be provided in any other suitable format, fashion, using any acceptable protocol, etc.). This can occur for each step of the process flow.

During these activities, the ASM maintains the state record, updating it on each step, and forwarding it to the next step processing function. In one sense, the ASM is systematically appending the new state. At any suitable point in time, the ASM can push the record back to the data store. The software developer can cause this to happen by how the processing function is coded. In each step of the processing, the developer can choose to: 1) maintain the record and processing on a same virtual machine (VM); or 2) push the record to the data store so that another VM can process the next step of the transaction. The reply from the application can be forwarded back through the ASM. In one embodiment, each step (request, reply, etc.) can be passed through to the ASM. Thus, the ASM is intercepting each event, decorating the state record, and then continuing to the next step (or pushing the record back to the data store).

Turning to FIG. 3, FIG. 3 is a simplified block diagram illustrating one potential example 75 associated with recorder manager instances. FIG. 3 includes a plurality of recorder manager instances 52a-n, a plurality of state managers 56a-n, a virtualization load balancer 60, and a protocol adapter 70 that is configured to receive bulk schedule requests.

In operation of one example embodiment, the previously described approach can be effectively applied to a cloud digital video recorder (DVR) Recorder Manager, as is shown in FIG. 3. In operation, protocol adapter 70 is configured to receive any number of incoming bulk recording schedule requests. The requests can be forwarded to load balancer 60 for distribution across a set of recorder manager application instances. The individual requests can be processed in parallel across the set of recorder manager instances. As the system grows in the number of subscribers with resultant higher transaction rates, additional server instances can be added to the system to provide more scale.

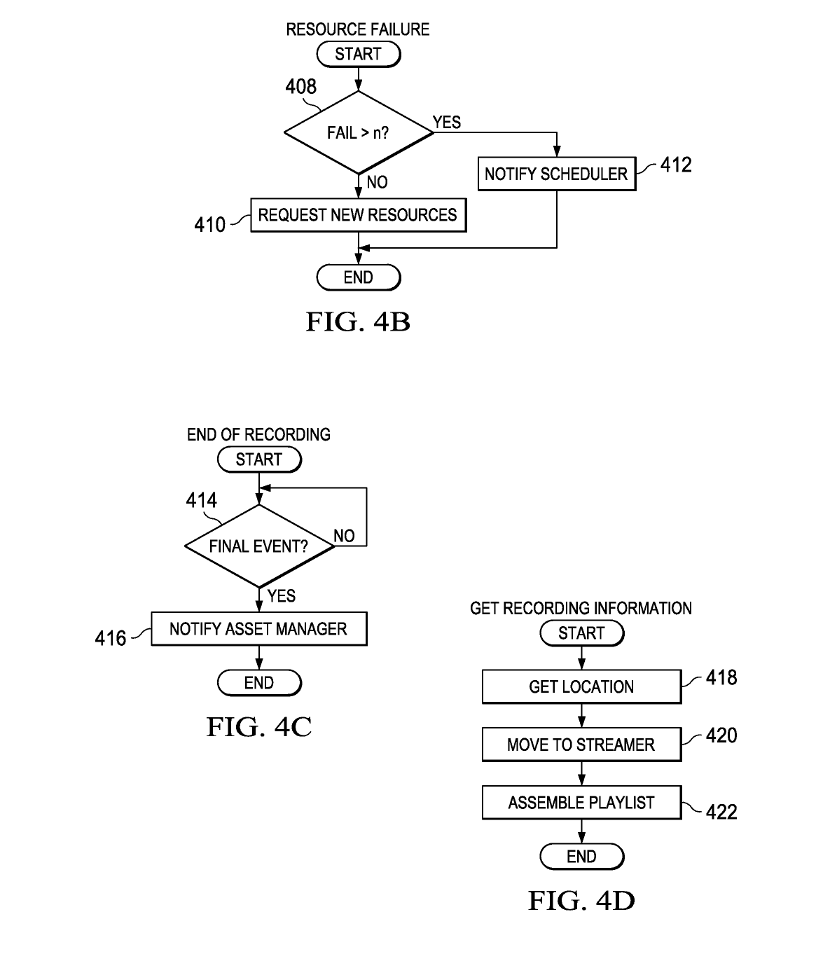

Turning to FIGS. 4A-4D, FIGS. 4A-4D are simplified flowcharts illustrating potential operations associated with the recorder manager event flows of the present disclosure. For example, in the context of a recording request, the flow may begin at 402 where resources are requested. Resources can be allocated at 404, where the asset manager (e.g., a recorder manager instance) would be notified at 406. For the case of resource failure, as is being depicted by FIG. 4B, if there is a failure decision identified at 408, then the scheduler would be notified at 412. If not, new resources can be requested at 410. Turning to FIG. 4C, this particular flow is associated with an end of a recording. In the case of a final event occurring, which is being shown at 414, the asset manager may be notified at 416. In terms of retrieving recording information, which is being illustrated by FIG. 4D, a location can be retrieved at 418. At 420, there is a move to a given streamer. The playlist would be assembled at 422.

Turning to the example infrastructure associated with the present disclosure, clients 12a-d can be associated with devices, customers, or end users wishing to receive data or content in communication system 10 via some network. The term ‘client’ is inclusive of devices used to initiate a communication, such as any type of receiver, a computer, a set-top box, an Internet radio device (IRD), a cell phone, a smart phone, a tablet, a personal digital assistant (PDA), a Google Droid, an iPhone, an iPad, a Microsoft Surface, a Google Nexus, or any other device, component, element, endpoint, or object capable of initiating voice, audio, video, media, or data exchanges within communication system 10. Clients 12-d may also be inclusive of a suitable interface to the human user, such as a display, a keyboard, a touchpad, a remote control, or any other terminal equipment. Clients 12-d may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

Networks 16a-16b represent a series of points or nodes of interconnected communication paths for receiving and transmitting packets of information that propagate through communication system 10. Networks 16a-16b offers a communicative interface between sources and/or hosts, and may be any local area network (LAN), wireless local area network (WLAN), metropolitan area network (MAN), Intranet, Extranet, WAN, virtual private network (VPN), WiFi network, or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber-to-the-x (FTTx), which is a generic term for any broadband network architecture that uses optical fiber in last-mile architectures, and data over cable service interface specification (DOCSIS) cable television (CATV). The architecture of the present disclosure may include a configuration capable of transmission control protocol/internet protocol (TCP/IP) communications for the transmission and/or reception of packets in a network.

In more general terms, clients 12-d, application state managers 30a-n, recorder manager instances 52a-n, and server instances 25a-n are network elements that can facilitate the state management activities discussed herein. As used herein in this Specification, the term ‘network element’ is meant to encompass any of the aforementioned elements, as well as routers, switches, cable boxes, gateways, bridges, load balancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, clients 12-d, application state managers 30a-n, recorder manager instances 52a-n, and/or server instances 25a-n include software to achieve (or to foster) the state management activities discussed herein. Additionally, each of these elements can have an internal structure (e.g., a processor, a memory element, etc.) to facilitate some of the operations described herein. In other embodiments, one or several devices may include any suitable algorithms, hardware, software, components, modules, interfaces, or objects that facilitate the operations thereof.

In certain example implementations, the stateful functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor [processors 50a-n shown in FIG. 2A], or other similar machine, etc.). In some of these instances, a memory element [memory element 27a-n shown in FIG. 2A] can store data used for the operations described herein. This includes the memory element being able to store instructions (e.g., software, code, etc.) that are executed to carry out the activities described in this Specification. The processor (e.g., processors 50a-n) can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the state management activities, as outlined herein. Additionally, each of these devices may include a processor that can execute software or an algorithm to perform the state management activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its techniques) are readily scalable and, further, can accommodate a large number of components, as well as more complicated/sophisticated arrangements and configurations. Accordingly, the examples provided should not limit the scope or inhibit the broad techniques of communication system 10, as potentially applied to a myriad of other architectures.

It is also important to note that the steps in the preceding FIGURES illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving an inbound request from a client;
retrieving state information for a targeted application;
modifying the inbound request with the state information from a data store;
forwarding the inbound request that was modified to an application running on a server instance; and
providing a response to the client based on information provided by the application.

2. The method of claim 1, wherein an application session manager (ASM) is provided to intercept a plurality of events associated with a transaction involving the inbound request, and wherein a state record is systematically updated by the ASM based on the plurality of events.

3. The method of claim 1, wherein state information from each step of a transaction is maintained as XML-structured information in a document associated with a session state record (SSR).

4. The method of claim 1, wherein the application running on server instance sees the inbound request that was modified as if the client had supplied the state information.

5. The method of claim 1, wherein the state information is retrieved for the targeted application at a distributed hash table (DHT) data store.

6. The method of claim 1, further comprising:
updating additional state information in the data store.

7. The method of claim 1, wherein an application session manager operates as a frontend to a plurality of client requests and for mid-session phases to transparently maintain and present state information at a beginning of a session transaction or session phase.

8. The method of claim 1, wherein an adapter is coupled to the client and configured to implement a legacy protocol and to convert an incoming message payload to an XML format.

9. The method of claim 1, wherein a load balancer is provided to distribute incoming requests from a plurality of clients across a set of stateless server instances.

10. The method of claim 1, wherein the inbound request is associated with a cloud digital video recorder (DVR) recorder manager that is to provide video content management for the client.

11. Logic encoded in one or more non-transitory tangible media that includes code for execution and when executed by a processor operable to perform operations comprising:
receiving an inbound request from a client;
retrieving state information for a targeted application;
modifying the inbound request with the state information from a data store;
forwarding the inbound request that was modified to an application running on a server instance; and
providing a response to the client based on information provided by the application.

12. The logic of claim 11, wherein an application session manager (ASM) is provided to intercept a plurality of events associated with a transaction involving the inbound request, and wherein a state record is systematically updated by the ASM based on the plurality of events.

13. The logic of claim 11, wherein state information from each step of a transaction is maintained as XML-structured information in a document associated with a session state record (SSR).

14. The logic of claim 11, wherein an adapter is coupled to the client and configured to implement a legacy protocol and to convert an incoming message payload to an XML format.

15. The logic of claim 11, wherein the inbound request is associated with a cloud digital video recorder (DVR) recorder manager that is to provide video content management for the client.

16. An apparatus, comprising:
a processor;
a memory element coupled to the processor and configured to store data, wherein the processor and the memory element cooperate such that the apparatus is configured for:
receiving an inbound request from a client;
retrieving state information for a targeted application;
modifying the inbound request with the state information from a data store;
forwarding the inbound request that was modified to an application running on a server instance; and
providing a response to the client based on information provided by the application.

17. The apparatus of claim 16, wherein the apparatus is further configured to:
intercept a plurality of events associated with a transaction involving the inbound request, and wherein a state record is systematically updated by the ASM based on the plurality of events.

18. The apparatus of claim 16, wherein state information from each step of a transaction is maintained as XML-structured information in a document associated with a session state record (SSR).

19. The apparatus of claim 16, further comprising:
an adapter coupled to the client and configured to implement a legacy protocol and to convert an incoming message payload to an XML format.

20. The apparatus of claim 16, further comprising:
a load balancer configured to distribute incoming requests from a plurality of clients across a set of stateless server instances.
